(19) United States
(12) Patent Application Publication
(10) Pub. No.: US 2026/0085377 A1
(43) Pub. Date: Mar. 26, 2026

(54) Rare Earth Solvent Extraction Cell and Process

(71) Applicant: The Saskatchewan Research Council, Saskatoon (CA)

(72) Inventors: Muhammad Imran, Saskatoon (CA); Jack Zhang, Saskatoon (CA); Erin Herman, Saskatoon (CA); Farrell Baird, Saskatoon (CA)

(21) Appl. No.: 19/106,686

(22) PCT Filed: Sep. 14, 2023
(86) PCT No.: PCT/CA2023/051223

§ 371 Date: Feb. 26, 2025

Related U.S. Application Data
(60) Provisional application No. 63/406,411, filed on Sep. 14, 2022.

(51) Int. Cl. C22B 3/26; B01F 23/43; B01F 33/81; B01F 101/45; C22B 59/00

(52) U.S. Cl. CPC C22B 3/26; B01F 23/43; B01F 33/811; B01F 2101/45; C22B 59/00

(57) ABSTRACT

A solvent extraction (SX) cell for rare earth recovery comprising a mixer and a settler. The mixer includes a height and/or position adjustable mixer impeller and/or a fluid retaining inlet collar around a lower portion of the mixer impeller and/or one or more sample ports across a height of the mixer. The mixer impeller controlled at least in part in response to analysis of a sample from the one or more sample ports. The settler includes an automated interface regulator and/or one or more interface detection sensor adapted to identify at least an interface between an aqueous layer surface and emulsion layer in the settler. The height of the automated interface regulator controls at least in part in response to the one or more interface detection sensor. A plurality of mixers and a plurality of settlers operatively connected in a modular layout to provide a battery of solvent extraction (SX) cells. A water seal is provided between a lid and walls of the mixers, the settlers, and/or the battery.

### FIELD

The disclosure relates generally to the field of the recovery of metals from raw ores or concentrates, and more specifically, to the recovery of rare earth elements, or oxides, chlorides, salts or other forms thereof, from ores containing bastnaesite, carbonatite, and/or monazite, and more specifically to solvent extraction cells therefor.

### BACKGROUND

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

Rare Earth is the name of a group of 17 individual elements, including yttrium (Y) and scandium (Sc), as well as 15 lanthanide elements: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). They are not really rare in the earth crust in comparison to base metals such as copper, nickel, lead, zinc, etc. However, rare earth elements (REEs) are often found together as a group in minerals such as bastnaesite, monazite, apatite, etc. To separate the rare earth minerals from the rock and divide the rare earth elements from each other may be difficult. Rare earth separation technology plays an important role in the rare earth mining and recovery industry.

Rare earth elements are important, as they have wide applications in many high technology areas. According to the Department of Energy of the United States, Neodymium (Nd), Dysprosium (Dy), Europium (Eu), and Terbium (Tb) are classified as critical based on their importance and low supplies. Rare earth elements have distinctive electrical, metallurgical, catalytic, nuclear, magnetic, and luminescent properties and are important for many advanced technologies, including consumer electronics, computers and networks, communications, clean energy, advanced transportation, health care, environmental mitigation, national defense etc. Usage ranges from daily use (e.g., lighter flints, glass polishing mediums, car alternators) to high-end technology (lasers, magnets, batteries, fibre-optic telecommunication cables).

Rare earth elements may be mined from the earth's crust as ore deposits and may be recovered through stages of physical and chemical separation processes. The physical separation process typically includes crushing, grinding, gravity separation, magnetic separation, electrostatic separation, sensor-based sorting such as X-ray sorting, and/or flotation. The chemical separation process may include calcination, roasting, leaching, fractional precipitation, ion exchange, and solvent extraction. The physical and chemical processes are often drastically different due to the unique characteristics of each ore deposit. Rare earth orebodies often have complicated mineralogy that makes the recovery and separation processes complicated, expensive, and environmentally challenging.

Rare earth elements are an essential component of modern technology and are widely used in the manufacturing of electric vehicles and wind turbines among others. There are many processing steps involved in the production of rare earths including mining, concentration, hydrometallurgy, separation, metal smelting, and magnet manufacturing. Each processing step require various unit operations and mechanical equipment to produce the product. The Separation process is a midstream operation where the rare earths are separated from each other. The conventional technology applied for this separation is called “Solvent Extraction”. The major equipment required for solvent extraction are “Solvent Extraction Cells” which has two components, “Mixer”and “Settler”respectively.

The feed to the cells is an aqueous solution that contains the rare earth elements, and it is mixed inside the Mixer with an organic phase, forming an emulsion. There may be a specific design ratio: aqueous to organic. After mixing, the emulsified fluid flows to a “Settler”, where after a certain residence time, emulsion of the aqueous and organic fluids separates and the rare earth elements are separated depending on their ion exchange affinity, some rare earth elements flow with organic phase and some with the aqueous phase. Depending on which rare earth elements are being separated, the number of cells can be varied up to over 500 cells. In some cases the mixer volume can vary from 300 litres to over 1000′s of litres and the settler volume can also vary from 1000′s of litres to over tens of thousands of litres.

The cells are operated in a continuous process and with proper dosing of various chemicals, for example NaOH, and HCl, after repeated mixing and settling, efficient separation is achieved. The cells are usually distributed to achieve the following steps during the separation process:
Extraction;
Scrubbing—e.g. Hydrochloric acid addition;
Stripping—e.g. Hydrochloric acid addition;
Washing—e.g. Fresh water addition; and
Saponification—e.g. NaOH addition.

The number of cells required in each of the sub process is different. In one example, to achieve the separation between group A (Lanthanum, Cerium, Neodymium, Praseodymium) and group B (mixture of medium and heavy rare earths) it may require 15 extraction cells, 10 scrubbing cells, 10 stripping cells, 6 washing cells and 4 saponification cells.

One of the key requirements of the solvent extraction process is that the design and operation performance of the cells yield over 95% recovery of the REEs in the Feed, and over 99% purity of the separated REEs. Conventional solvent extraction cells have some design deficiencies, which can impact the performance of this process. For example, design deficiencies may include that it is difficult and time consuming to balance flow rates with manual operation and/or ensuring efficient mixing.

It is therefore desirable to provide an improved solvent extraction cell to improve the solvent extraction process performance.

### SUMMARY

It is an object of the present disclosure to obviate or mitigate at least one disadvantage of previous solvent extract cells.

In a first aspect, the present disclosure provides a solvent extraction (SX) cell including a mixer, having one or more sample port across a height of the mixer and a mixer impeller for drawing an organic phase fluid and an aqueous phase fluid into the mixer from a bottom inlet and/or for mixing said fluids in the mixer, at least one sensor adapted to analyze samples from the one or more sample port, a fluid retaining collar, at the inlet around a lower portion of the mixer impeller, a mixer impeller drive, a controller adapted to adjust a vertical position of the mixer impeller and/or a rotational speed of the mixer impeller responsive to at least analysis of the samples, and a settler, operatively connected with the mixer.

In a further aspect, the present disclosure provides a mixer impeller for a mixer of a solvent extraction (SX) cell including an upper disk, having a mixer impeller diameter d, having at least one recirculation opening, a plurality of vanes, extending away from the upper disk to a lower opening inlet of the mixer impeller, a distance between the upper disk and the lower opening defining a mixer impeller height h, wherein a mixer impeller ratio of h/d is greater than 1.

In a further aspect, the present disclosure provides an automated interface regulator for a solvent extraction (SX) cell including a settler, having an aqueous take off divider having an open bottom portion and an adjustable interface regulator, one or more interface detection sensor adapted to identify at least an interface between an aqueous layer surface and emulsion layer in the settler, an automatic interface regulator control, adapted to adjust a height of the adjustable interface regulator responsive at least to the one or more interface detection sensor, and a mixer, operatively connected with the settler.

In a further aspect, the present disclosure provides a water seal for a battery of solvent extraction (SX) cells including a plurality of mixers and settlers operatively connected, a trough extending around an outer perimeter of an outer wall of the battery, the trough adapted to contain a level of water, a lid having serrated edge extending around a perimeter of the lid, the edge adapted to sit in the trough, wherein the water seal is formed between the lid and the outer wall.

In a further aspect, the present disclosure provides a battery of solvent extraction (SX) cells including a plurality of mixers and a plurality of settlers operatively connected in a modular layout, at least one shared wall between adjacent solvent extraction cells; and at least one internal flow channel between the operatively connected solvent extraction cells.

In a further aspect, the present disclosure provides a pack flat solvent extraction (SX) cell including a plurality of flat sheet parts, said plurality of flat sheet parts adapted for assembly into a mixer and/or a settler for a solvent extraction cell at a desired location, wherein the parts may be stacked flat for efficient transportation and then assembled at the desired location.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a battery of solvent extraction (SX) cells of the present disclosure.

FIG. 2 is a side view of the battery of FIG. 1.

FIGS. 3A, 3B are side views of the battery of FIG. 1.

FIG. 4A is a side view of the battery of FIG. 1.

FIG. 4B is a section A-A of FIG. 4A.

FIG. 5A is a side view of the battery of FIG. 1.

FIG. 5B is a section B-B of FIG. 5A.

FIG. 6A is a side view of the battery of FIG. 1.

FIG. 6B is a section C-C of FIG. 6A.

FIG. 7A is a side view of the battery of FIG. 1.

FIG. 7B is a section D-D of FIG. 7A.

FIG. 8 is side section view of a plurality of solvent extraction (SX) cells of the present disclosure.

FIG. 9 is a detail view of a mixer and sampling port of a solvent extraction (SX) cell of the present disclosure.

FIG. 10 is a detail view of a mixer inlet and mixer impeller of a solvent extraction (SX) cell of the present disclosure.

FIG. 11 is a mixer impeller assembly for a mixer of a solvent extraction (SX) cell of the present disclosure, and FIG. 11A is an enlarged detail view of an exemplary vane of a mixer impeller of the present disclosure.

FIG. 12A is a perspective detail view of a mixer impeller of the present disclosure, inverted from FIG. 11.

FIG. 12B is side view of the mixer impeller of FIG. 12A, with the lower portion to the left and the upper portion to the right and FIG. 12C is a side view of the mixer impeller of FIG. 12A, with the lower portion to the right and the upper portion to the left.

FIG. 12D is a section A-A view of FIG. 12B, and shows the lower portion, inlet side.

FIG. 12E is a top view a mixer impeller of FIG. 12A, and shows recirculation ports. FIG. 12F is a perspective view of an upper disk of the impeller mixer of FIG. 12A, showing an inner surface with vanes removed for illustration purposes.

FIG. 13 is a detail view of a settler and adjustable interface regulator of the present disclosure.

FIG. 14 is a water seal for a solvent extraction (SX) cell or group of said cells of the present disclosure.

FIG. 15 is a 6-cell battery flow arrangement with standard flow.

FIG. 16 is a 6-cell battery flow arrangement with modified flow, where cells 2 and 3 are bypassed.

FIG. 17 is a sketch of a recycle stream.

FIG. 18 is a sketch of a recycle stream.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Throughout this disclosure, where a range is used, any number between or inclusive of the range is implied.

Generally, the present disclosure provides a solvent extraction cell and/or solvent extraction cell features to improve solvent extraction aspects of recovery of REEs.

### Modular Layout

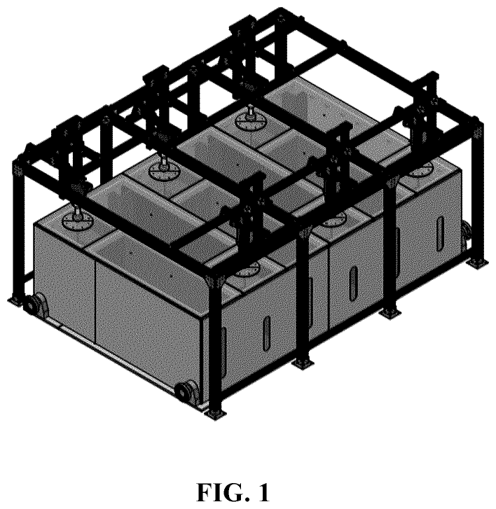

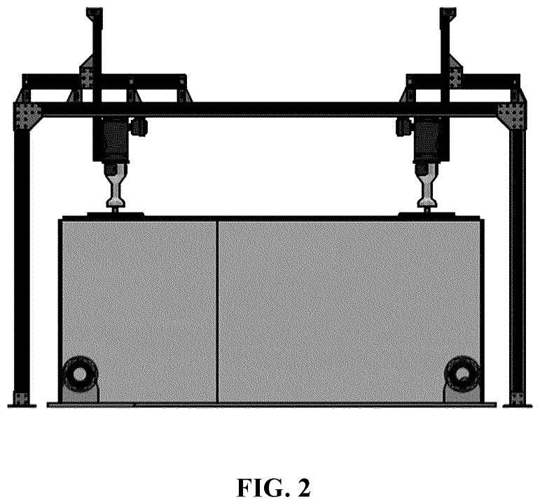

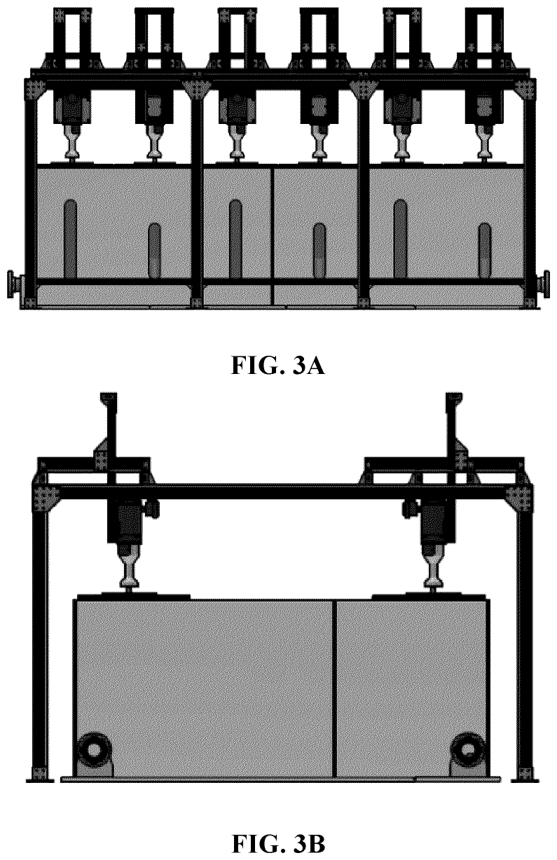

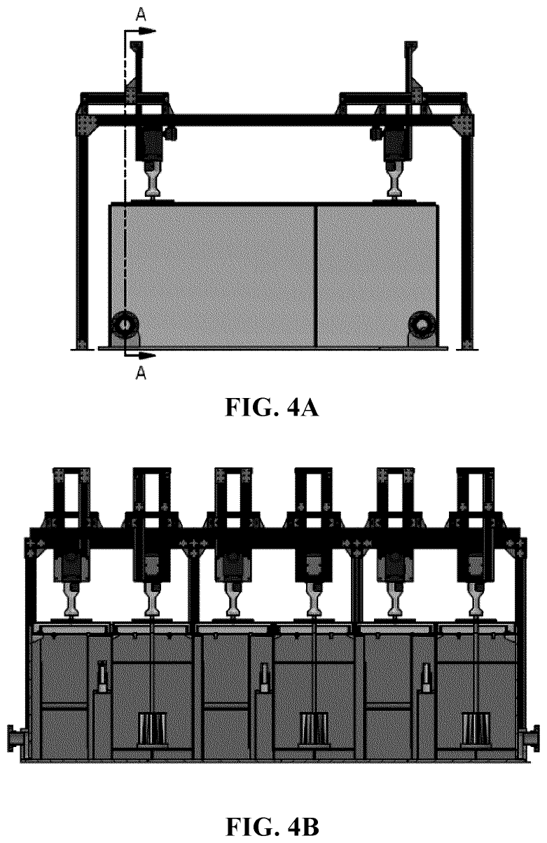

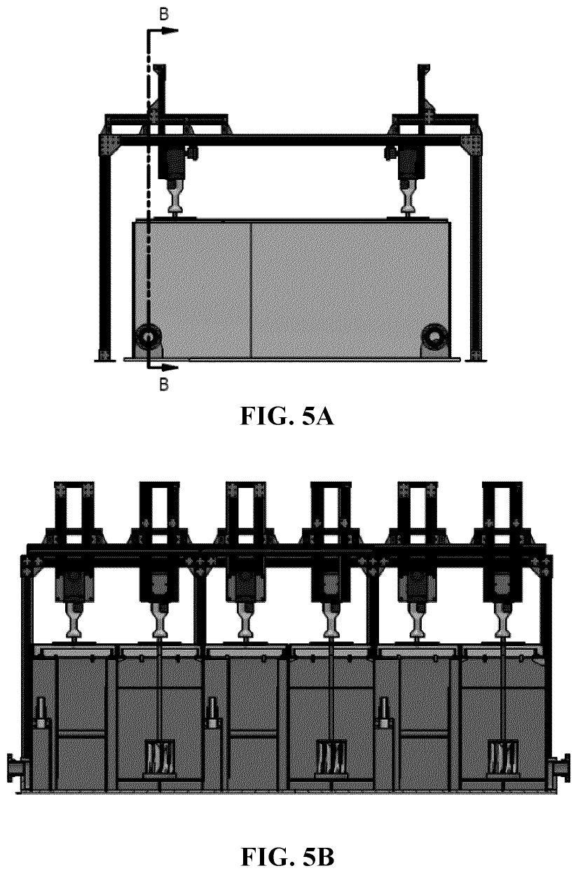

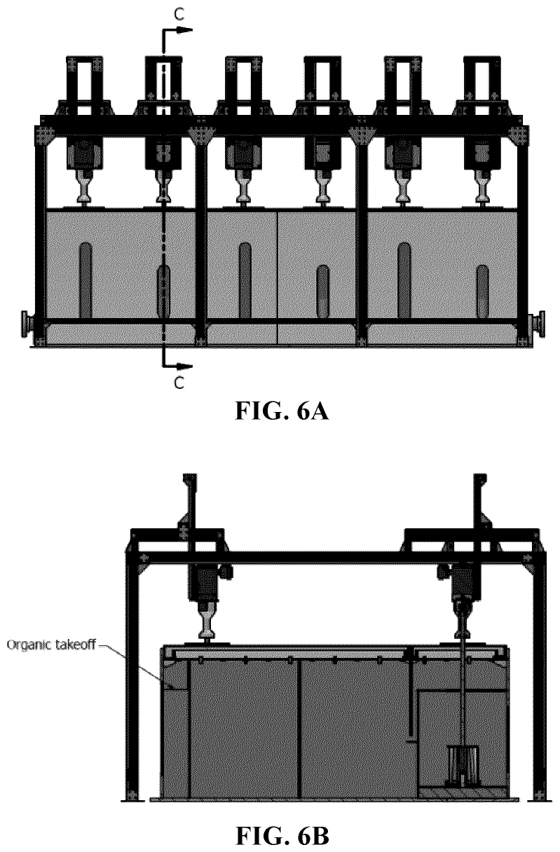

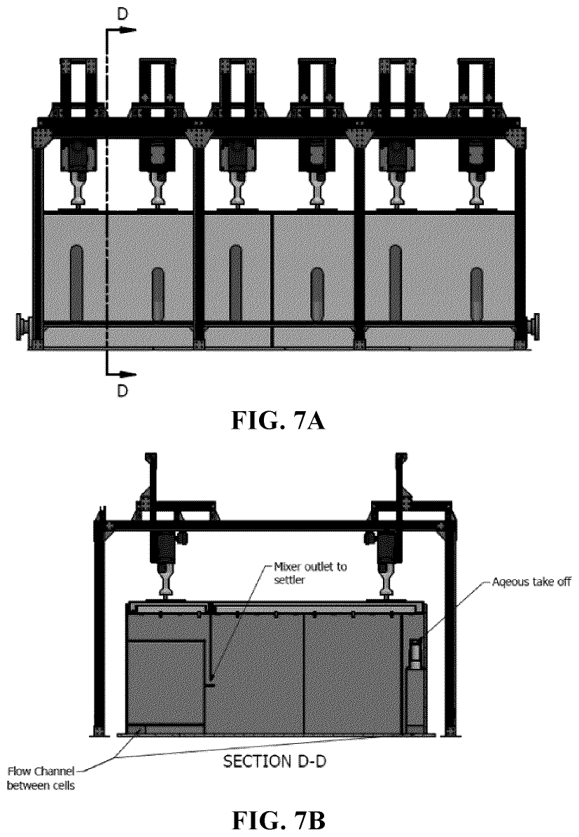

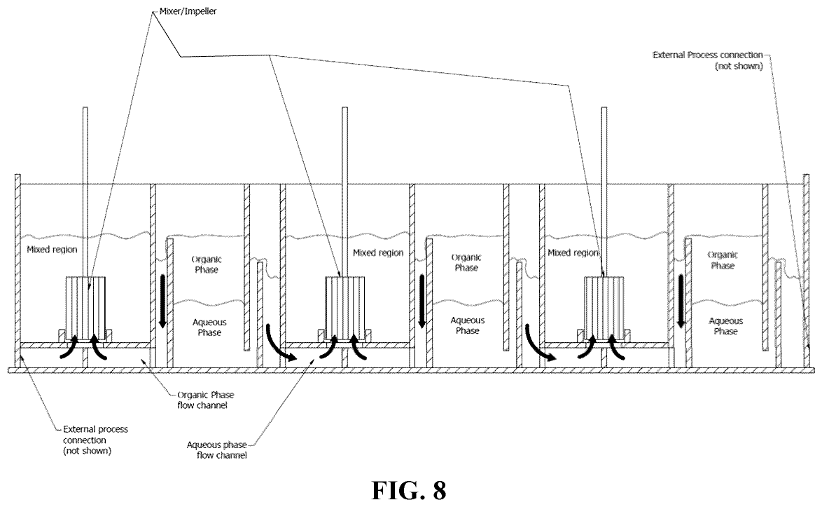

Referring to FIGS. 1-8, in an embodiment disclosed, a plurality of solvent extraction cells are operatively connected as a system to form a battery. The Battery could include any number of cells convenient for construction. Each cell has a mixer and a settler. Aqueous phase fluid and organic phase fluid enter the mixer proximate the bottom area, via an inlet under a mixer impeller. Mixed fluid eventually exits the mixer through a port in the top of the mixer as it is displaced by incoming fluid. The mixed fluid exits the top of the mixing cell and then flows to the settler. Solid plates direct the mixed emulsion fluid from the mixer to enter the settler in a middle region of the fluid mass, in a very smooth transition at low velocity so as to not introduce turbulence and minimize the amount of disturbance to the already settling fluids.

Referring to FIG. 8, in an embodiment disclosed, solvent extraction (SX) cells may be constructed in a modular layout.

Cells are constructed in modules with shared walls which may provide several benefits:
Reduces plant footprint through a more compact design;
Hardware requirements are reduced through the method of routing fluid flow between adjacent cells that is internal to the cell design. This may reduce cost in several ways: less external piping required, reduced assembly and construction labor since interconnecting piping which would otherwise connect the cells is not built, transported, warehoused, installed, tested etc.;
Modular design where cells share walls. Reduces material requirements compared to individually constructed cells. Cell walls can be thinner since fluid load is balanced reducing material requirements and bracing (cheaper, material savings) this results in more efficient use of construction materials; and
Efficient, faster construction and onsite assembly.

### Mixing

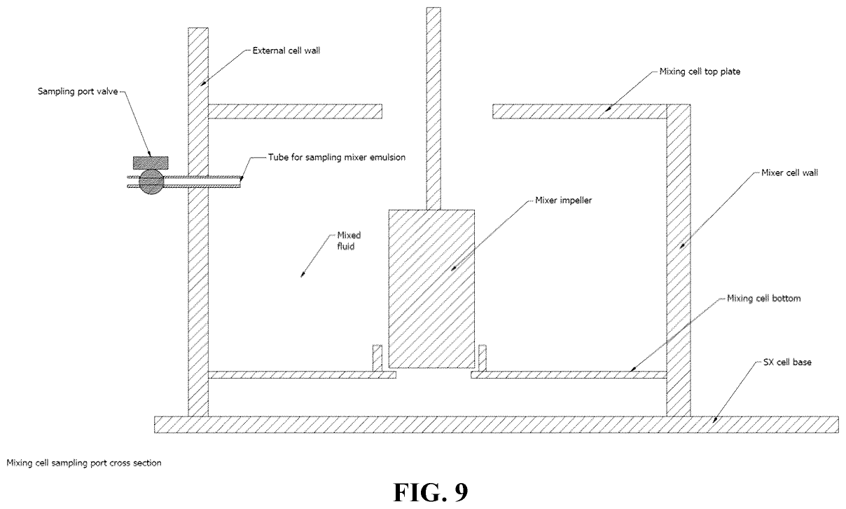

Referring to FIG. 9, in an embodiment disclosed, the mixing efficiency and/or mixed fluid condition may be monitored and/or assessed, for example in real-time. In an embodiment disclosed, mixing action and/or pumping action may be improved.

The separation performance in the settler of the cell is heavily dependent on proper mixing in the mixer. In the mixer it is important to achieve near/substantially homogeneous mixing with a desired/selected proper ratio of organic phase fluid and aqueous phase fluid. Too much of either solution in the mixer can result in poor ion exchange. If mixing is insufficient then the fluids do not get fully mixed, but if mixing is excessive then a persistent emulsion may form, resulting in wasted energy and inefficient separation, and wear on agitator drive components. Any of which may reduce the efficiency of the process and potentially affect the economic viability of the process. Additionally, an imbalance can lead to the creation of a persistent emulsion in the mixer that will not break in the settler. Depending on the volume of the mixer, the residence time in the mixer may be less than five minutes. Therefore it is important to have frequent, for example real-time or near real-time monitoring and/or analysis of the mixed fluid to make proper and timely adjustments and/or settings. Conventional solvent extraction mixers lack the ability to monitor and control real time mixing and pumping efficiency impacting the steady state operation of the solvent extraction process.

The disclosed design offers the provision to draw samples across the mixer height, to analyze them on real-time basis and take necessary actions to ensure the proper mixing of two immiscible fluids. One such sample port is illustrated in FIG. 9. However, additional sample ports may be provided across the mixer height, to determine the progression and/or state and/or uniformity etc. of one or more parameter of the mixed fluid.

To these ports, one or more sampling system may be connected to analyze and/or measure the organic to aqueous ratio for use in making adjustments to the appropriate system. For example, adjustments may include one or more of organic solution feed rate, aqueous solution feed rate, mixer impeller speed, mixer impeller stop/start, mixer impeller direction of rotation, mixer impeller vertical position or cell recirculation. If the fluid ratios are out of balance, then the operator can adjust the flow rates of one or both of the aqueous or organic fluids, or engage a recirculation circuit which recycles a portion of one of the fluids from the outflow of the cells to increase the effective flow rate of that fluid within the cells, without affecting the overall flow rate as measured at the inlet and outlet of the cells.

In an embodiment disclosed the sampling systems are automatic and/or real-time. “Automatic” means via an electronic computer controlled system. The sampling system may provide the ratio between the two phases (organic and Aqueous) at one or more region/height in the mixer. The sampling system may also provide an indication/measurement of how long it takes the emulsion to break. This would tell the operator/system designer if the mixer is over agitating and creating an emulsion that will not readily settle out in the settler. The sampling system, with a plurality of sample points on each mixer may also be used to compare the different samples to determine consistency between them and make adjustment(s) if required to ensure consistency.

The system may provide a visual and/or audible notification and/or provide a control output suitable for input into one or more control system based at least in part on the one or more samples. The control system may, for example, adjust one or more parameter of the solvent extraction cell based on the control output. The one or more parameter may include one or more of the vertical position of the mixer impeller, rotational speed of the mixer impeller, direction of rotation of the mixer impeller, stop/start of mixer impeller rotation, feed rate for the aqueous fluid or feed rate of the organic fluid. In an embodiment disclosed, a temporary pause of the mixer may be initiated to allow a period of time to pass in order for the system to clear an upset or off-specification condition, after which normal operation resumes. The pause may be predetermined based on experimental or theoretical values. Such upset or off-specification condition may, for example, be an unintentional development of a persistent emulsion.

In an embodiment disclosed, one or more window is provided in a wall of the mixer to allow visual observance of the contents of the mixer and/or the settler (see e.g. FIG. 1). The visual observance may be used by a human operator and/or sensor and/or image system (e.g. still and/or moving image camera) to aid in operation and/or verify operation of the system.

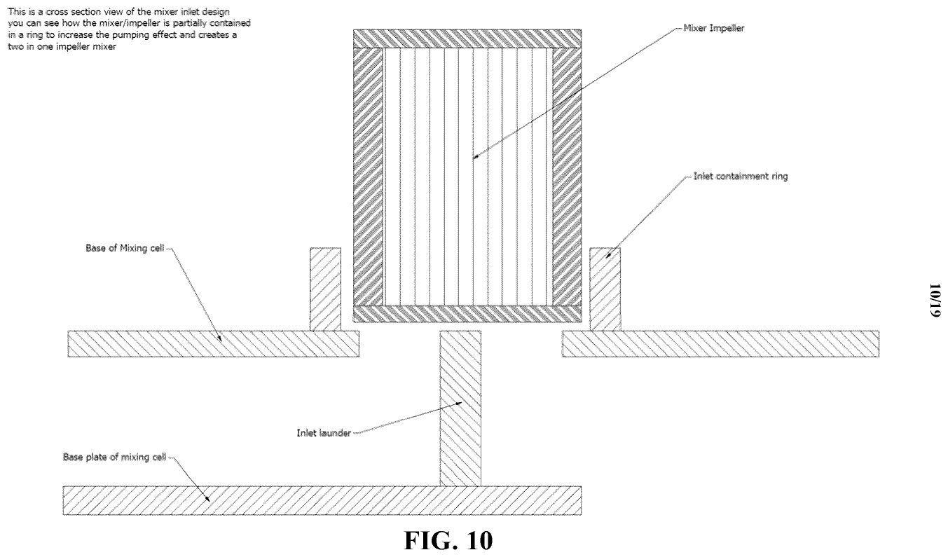

Referring to FIG. 10, a mixer impeller provides sufficient pumping to draw fluid into the mixer as well as mix the fluid sufficiently to promote ion exchange between the aqueous feed stock and the organic separation phase. The pumping of the fluid is important to maintain consistent flow between adjacent cells in the process, e.g. operatively connected upstream and/or downstream. If the pumping capacity is too low, then fluid backs up in the preceding cell or cells which reduces flow rates and system efficiency. If pumping is too aggressive, it can cause air to be drawn into the mixer impeller inlet and/or cause cavitation, resulting in undesirable foaming and persistent emulsion in the mixer.

The mixer impeller sits inside an inlet containment ring or “collar”, and the clearance between mixer impeller and the collar walls impacts the pumping and/or mixing performance. Too little clearance may result in shear forces within the fluid. The clearance may be any suitable clearance. In an embodiment disclosed, the clearance may be between about 2 mm to about 50 mm, about 4 mm to about 40 mm, about 5 mm to about 25 mm, about 5 mm to about 15 mm, about 5 mm, about 10 mm, about 15 mm. The clearance may be less than 2 mm. The clearance may be more than 50 mm. The collar provides better separation between the unmixed fluid in the mixer inlet and the mixed fluid within the mixer. It also reduces or prevents recycling of partially mixed fluids back into the inlet area below the mixer impeller which could displace the inlet fluid stream and affect the overall fluid ratio. The collar helps to provide controlled fluid flow into the mixer impeller which improves the mixing efficiency. The mixer impeller design creates and affects the pumping action, and an optimized mixer design impacts the power requirements of the solvent extraction cell and overall extraction process. Without the collar mixing or pumping efficiency may be compromised by fluid recycling back to the inlet. The mixer impeller design and interface with the collar helps prevent the two fluids in the mixer inlet from developing any crossflow. The collar may preferably be a circular annular ring, but may be otherwise shaped, for example but not limited to a polygonal shape, e.g. hexagon, octagon, etc.

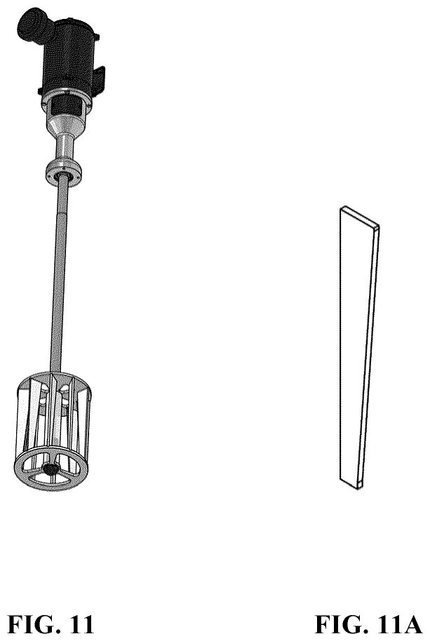

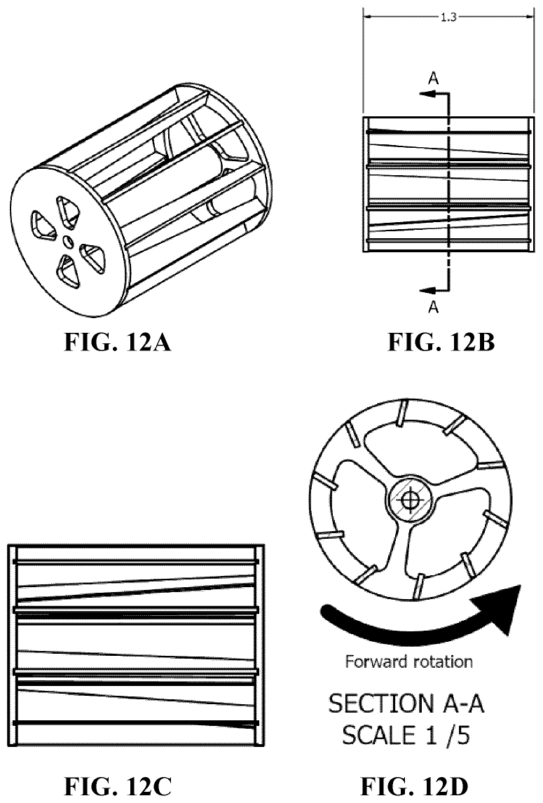

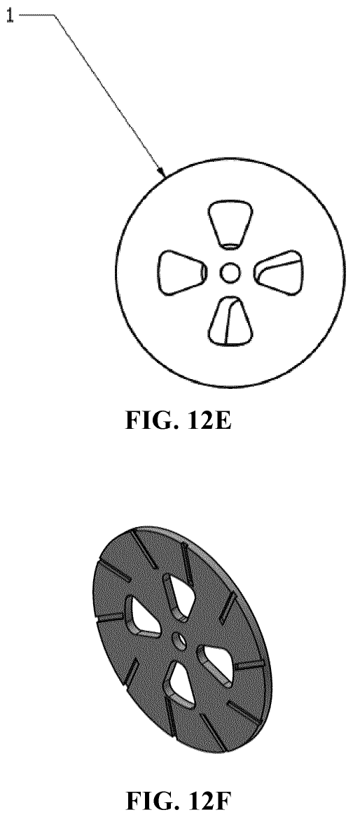

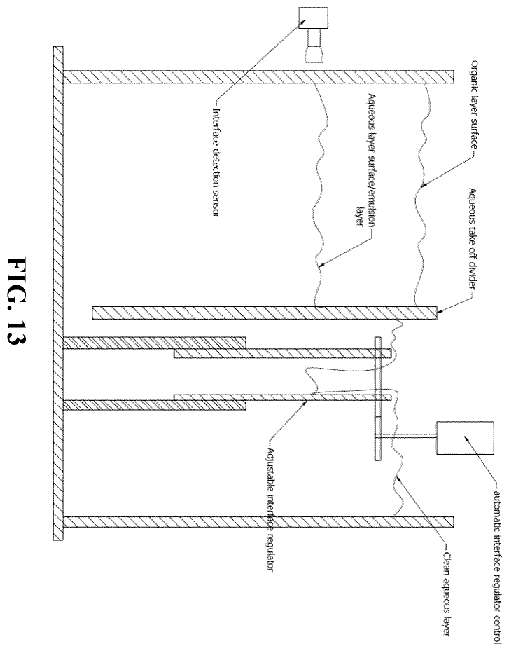

Referring to FIGS. 11 and 12A-12F the mixer impeller may be generally cylindrical, having a lower portion with a plurality of openings, an upper portion with a plurality of openings, and a plurality of vanes between the lower portion and the upper portion. The mixer impeller has an aspect ratio (height/diameter or h/d) sufficient to create a circulation of fluid from below the mixer impeller (fluid inlet flow) and also recycle mixing of already mixed fluid from within the mixer body. The recycle fluid is drawn into the mixer impeller through recycle fluid holes in the upper disk of the mixer impeller body. The height/diameter ratio may be any suitable ratio. The h/d ratio may be about 1, about 1 to about 4, about 1 to about 3, about 1 to about 2, about 1.1 to about 1.5, about 1.2 to about 1.4, about 1.3. The ratio may be greater than 4.

One or more of the plurality of vanes may be angled relative to the direction of rotation of the mixer impeller. The mixer impeller is rotated by a rotary drive, for example, an electric motor. One or more of the plurality of vanes may be angled in a direction opposite to the rotation of the mixer impeller (see e.g. FIG. 12D) and/or one or more of the plurality of vanes may be angled in the same direction as the rotation of the mixer impeller. One or more of the plurality of vanes may be radial vanes. One or more of the plurality of vanes may have a vane profile. As an example, the vane profile may be an expanding profile, with a width of a vane increasing across the length of the vane, e.g. as in FIGS. 11, 11A, 12A, 12B, 12C. As an example, the vane profile may be a uniform profile, with a vane width substantially uniform across the length of the vane.

The rotary drive may include a gear reduction and/or a variable speed (e.g. frequency) drive. The impeller speed may be any suitable speed. The impeller may be rotated at a speed of, for example, between about 0 to about 900 rpm, between about 0 to about 450 rpm, between about 100 to about 400 rpm, between about 0 to about 350 rpm, about 0 rpm, about 100 rpm, about 200 rpm, about 300 rpm, about 400 rpm, about 500 rpm, about 600 rpm, about 700 rpm, about 800 rpm, about 900 rpm. The impeller speed may be more than 900 rpm.

The mixer impeller may have one or more opening in the top/upper disk which is designed to allow the impeller to draw fluid from the interior of the mixer body and provide additional mixing by recycling/recirculating it back through the mixer impeller. The mixer impeller has a large height/diameter ratio which can create a pressure drop further away from the inlet (bottom) of the mixer impeller. The reduced pressure area can be utilized to draw fluid from the mixer back into the mixer impeller to re-mix the fluids.

The mixer impeller assembly may be mounted on a framework above/around the solvent extraction cell or battery (see e.g. FIG. 1). In order to adjust the vertical position of the mixer impeller relative to the floor of the mixer and/or the collar, the mixer impeller assembly may be movable up and/or down by an actuator. The actuator may be, for example, a linear actuator.

The bottom of the impeller may draw fluid in. The top of the impeller may mix and recirculate. A two-bodied impeller may be used each performing one of these functions.

The impeller may have a top disk with holes in it. An important function of the holes is the recirculation of fluid back into the impeller. It should be apparent that the same goal could be accomplished with other impeller designs. For example, the same goal could be accomplished with an open vaned impeller which is designed without a top disk that can draw previously mixed fluid back into the impeller. Other possible designs could do this as well. For example, instead of a top disk, the impeller may have a “ring”or other shape.

The impeller may have vanes in a straight, vertical orientation. However, the vanes do not have to be in a straight, vertical orientation. For example, the vanes may be contoured or curved like a jet turbine, or other pump vane designs.

### Automated Interface Regulator

Referring to FIG. 13, in an embodiment disclosed, an automated interface regulator is provided for adjustment/control of cell fluid levels, for example continuous and/or real-time adjustment, for example to obtain and/or maintain steady-state operation.

Due to the mixing of two immiscible phases (aqueous phase and organic phase), an emulsion layer is formed in the settler and with improper mixing, the thickness and properties of the emulsion layer falls out of required limits, impacting the separation efficiency. Conventionally, the interface thickness and aqueous fluid level is controlled manually by adjusting a valve which regulates the aqueous flow out of the settler. The regulator in form is like a weir with adjustable height. The flow rate over the weir/regulator sets the flow rate from the settler into the next mixer or cell. The valve is also used to adjust the volume ratio of the aqueous and organic phases, which is required to be for example 1:1. An increase in thickness of the emulsion layer impacts this volume ratio and reduces separation efficiency. To maintain the thickness of the emulsion layer within required limits, extensive coordination among skilled plant operators is required. At the startup of the process or in case of a disturbance or upset, it can take months before steady-state operation is achieved. A significant drawback of prolonged non-steady state operation is loss of the valuable product in waste, significant reduction in both rare earth recoveries and purity and ultimately negative impact on plant operation and economics.

The disclosed design incorporates an automated interface regulator that will maintain and control the interface level in one or more solvent extraction cells resulting in the overall fluid balance of the whole system. In any given solvent extraction process, there are typically upwards of 90 individual cells that each require adjustments to the interface regulator. Manual adjustment to each of the regulators can take considerable amounts of time as each adjustment will influence every cell downstream of it and as a result it can take months to reach steady state. Sometimes many iterations of adjustments may be needed to achieve steady state and then redone for each upset or change in inlet flow rates.

In an embodiment disclosed, the system uses an interface level detection sensor. The interface level detection sensor may include, for example, a visual/camera system using A.I. or algorithm based level detection, or more conventional ultrasonic or physical detection sensors to determine the level of one and/or each fluid and interface emulsion height. The interface level detection sensor may provide an indicator and/or alarm to an operator and/or be used to control the actuation of an interface regulator resulting in a closed loop controller. Machine learning, artificial intelligence (AI), and/or other control and/or algorithms may be used to monitor the interface level in a number of cells operatively connected (e.g. up to substantially all cells within a battery), each having an interface regulator, and apply adjustments to the interface regulator of each cell as needed. This system will reduce or eliminate the need for multiple operators making coordinated adjustments manually over long periods of time. The ability to achieve steady state conditions in a shorter period of time is an important design feature of the disclosed cells.

Automated regulator features:
Makes the system automatically adjust to varying flow rates;
Decreases sensitivity to variations in feed characteristics;
Ensures optimal or improved performance of all the cells by reducing fluctuations in flow rates and achieving steady-state more quickly.
Ensures cell-to-cell flow rates match the input flow rate. Rapid or unexpected drops in fluid levels result in the mix ratios to be affected in the downstream cells, since the displaced fluid travels there. Rapid increases in fluid level in one cell deprives downstream cells of fluid in the same manner;
Due to hydrodynamic pressure, an increase of fluid level means more fluid will flow by gravity over the adjustable weir since the only restriction is the fluid viscosity. This means the system automatically adjusts for changes in fluid characteristics (density and viscosity), as the fluid viscosity resists flow over the weir, so since the weir is being adjusted to maintain the fluid level, the viscosity and density (and by association, temperature) is already accounted for;
Reduces reliance on operator adjustments and makes the normally challenging/time consuming process of balancing inter-cell flow rates very easy and not reliant on operator input, training, expertise, etc.; and
Level sensing control system works in a predictive and proactive manner so it is not purely a reactive control loop. In an embodiment disclosed, a flow meter may be provided on inlet to measure “future load” and proactively start adjusting the regulators downstream pre-emptively. As above, machine learning, AI and other control techniques may be utilized.

It is desirable to measure and control the system early and even make predictive changes based on an incoming stream.

### Water Seal

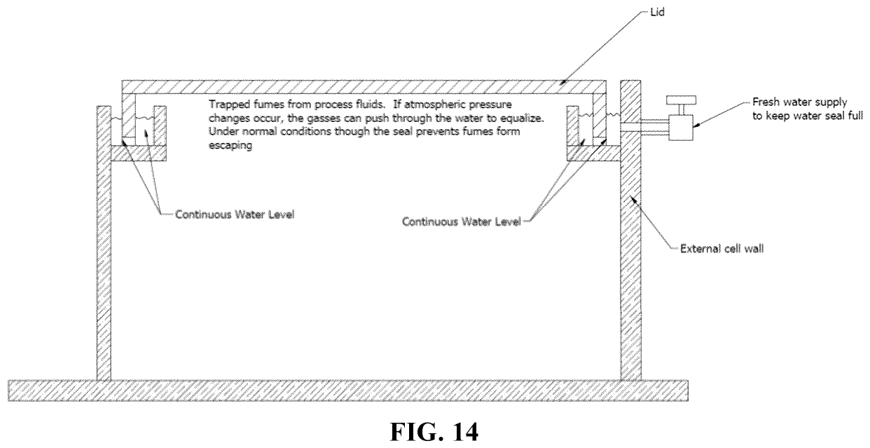

Referring to FIG. 14, in an embodiment disclosed, a water seal is provided for a solvent extraction cell, for example a continuous and/or self-leveling water seal.

One of the issues surrounding solvent extraction cell technology is that fumes from the organic fluid, caustic and/or corrosive chemicals used can result in concerns for worker safety from exposure. In an embodiment disclosed, a continuous water seal is provided for each of the cell batteries that provides a vapor seal without the need for complex or expensive polymer seals secured by clamps or fasteners which are typically used.

The water seal works by holding a reasonably small volume of water in a trough that extends around the perimeter of the cell that is continually monitored and/or controlled to maintain the correct water level, and the edge of the lid simply sits in the trough. The lid has a perimeter edge which is serrated. The serrated edge allows water to flow across the edge and maintain the same fluid level inside and outside of the lid. If atmospheric pressure decreases it is possible for a small amount of vapor to push past the water to escape and safely equalize the pressure inside of the seal. The water level is maintained by addition of a fluid, e.g. water supply. Alternatively, a vent line can be attached to the cells to allow controlled venting. The water seal is designed in such a way that gases and vapors can equalize between the cells and are not individually contained.

In an embodiment disclosed, the water seal seals an entire top of a battery of solvent extraction (SX) cells so that both the mixers and the settlers of the solvent extraction (SX) cells within the batter are within a single lid. However, the water seal may be used individually on a mixer, a settler, and/or a solvent extraction (SX) cell.

### Cell Design for Efficient Transport

In an embodiment disclosed, the solvent extraction (SX) cells are constructed from flat sheet parts instead of molded or pre-cast single bodies. The parts can be stacked compactly for more efficient transport and then assembled at a desired location. When the parts are assembled, a moderately small team with a few tools can assemble the cells. Transportation costs can be significant for single body cells (tanks) which are traditionally molded at a factory and then shipped whole.

### Adjusting the Quantity of Cells

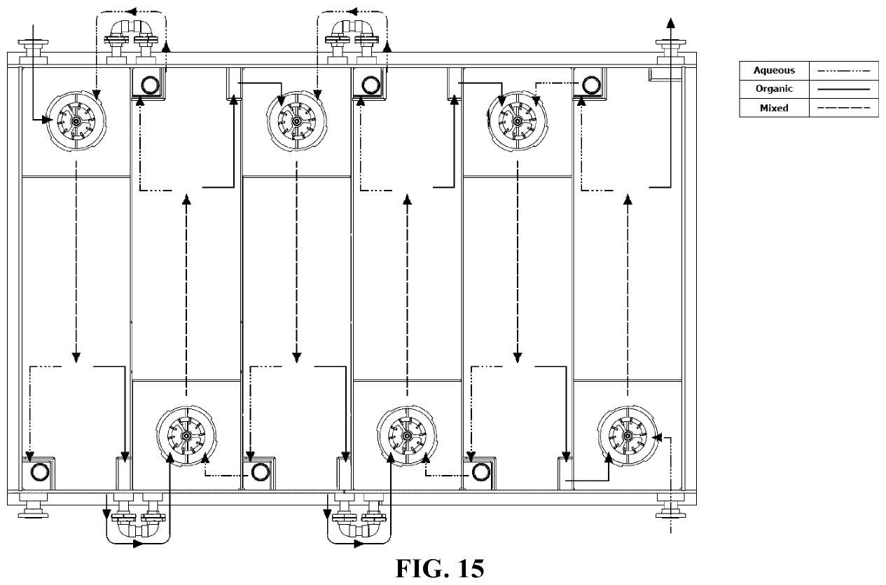

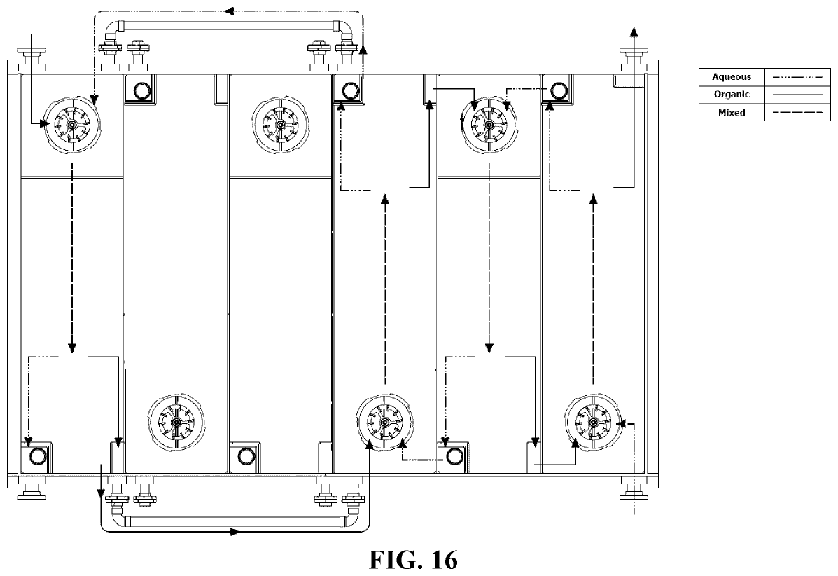

The solvent extraction (SX) cells may be configured in such a way as to make it possible to adjust the quantity of cells which are engaged in the five main processes of extraction, scrubbing, stripping, washing, and saponification. Each separation process may be done in a bank of cells (or a battery arrangement). The bank of cells may contain various numbers of cells dedicated to each of the five processes described above. Separation of the rare earth elements occurs progressively through the bank, namely, through the extraction, stripping, and scrubbing cells. Adjusting the quantity of cells in each process is done by changing the design of cells so that related piping and valving can be attached. The extra piping and valving is designed so that if needed, additional cells can be engaged for the above processes. Alternatively, if possible, the number of cells used in various operations can be reduced by bypassing some of the cells. FIG. 15 shows a 6-cell battery flow arrangement with standard flow. FIG. 16 shows a 6-cell battery flow arrangement where the flow to cells 2 and 3 is bypassed.

A reason it may be advantageous to adjust the quantity of cells is to accommodate variability in the feedstock, optimize the process for the actual separation efficiency, or reduce the residency time of the product in the various stages and thus increasing the overall capacity of the system. Another benefit is that if the number of cells can be reduced, it reduces the capital and operating cost of the system by proportionately reducing the quantity of chemicals and reagents used in the system. Alternatively, if higher overall system capacity is needed, then the operators could maximize the capacity by increasing flow rates through the entire system. This may result in reduced separating efficiency per cell but by increasing the number of cells, this will increase the total system capacity.

The ability to bypass an individual cell or group of cells may also provide system redundancy, since a cell which could become damaged, plugged, or otherwise inoperable could be bypassed without interfering with the overall process. The cell in question could then be serviced or have maintenance work done or even be replaced without disrupting the complete system.

FIG. 8 shows internal routing how material flow between adjacent cells within a battery. In the multi-configuration design described above, come of the internal routings are changed so that the routing is external and accomplished by attaching external pipes (see FIG. 15). This is done strategically since in this embodiment not all individual cells will need the bypass capability. For example, if the extraction process design criteria indicates a given number of cells is required, then the adaptability configuration may only need to be able to allow a portion of the cells to be bypassed or added (e.g. up to 40%). FIG. 16 shows the 6-cell battery flow arrangement of FIG. 15 except that the flow to cells 2 and 3 is bypassed.

### Recycling Streams

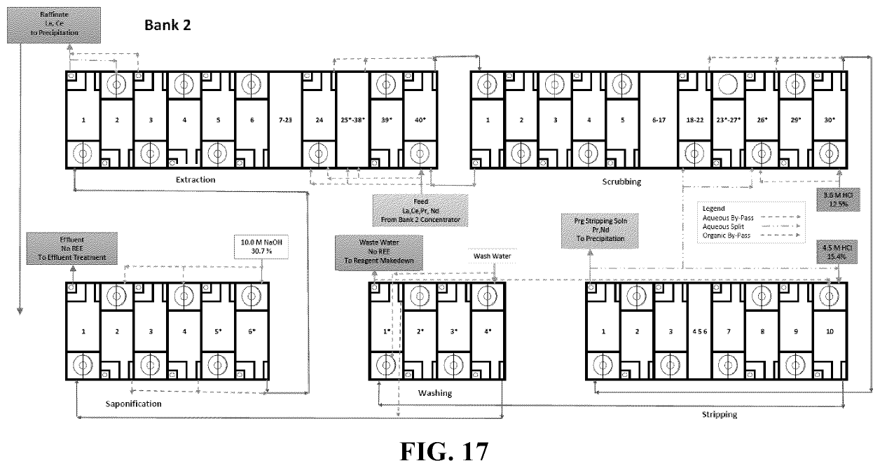

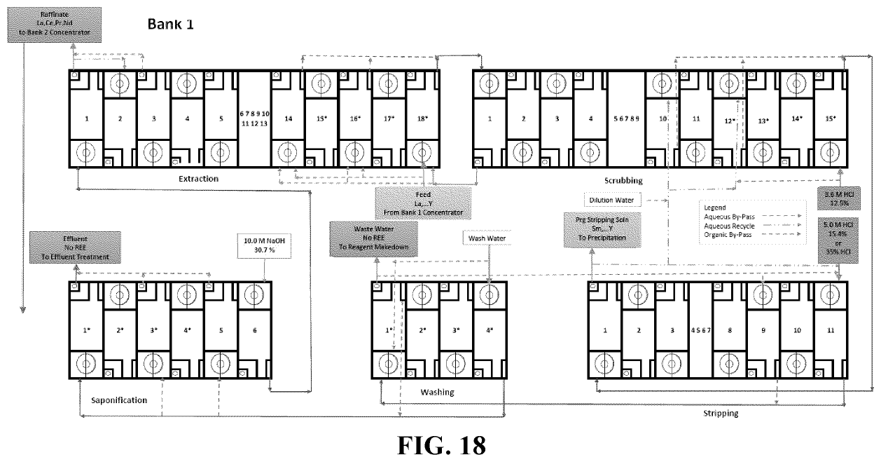

The process described herein may include recycling streams. FIGS. 17 and 18 show solvent exchange (SX) bank sketches with recycling streams. This is a system of piping and valving which is set up in such a way to allow operators to easily recycle all or a portion of the various process streams back to the start of the process. A reason to do this is that during startup or upset conditions, the separation of the rare earth elements in the solvent extraction process may be unstable or have not reached steady state. By using this recycling capability, materials that have not been fully separated may be sent back to the start of the process stage until such time a steady state has been achieved or complete separation has occurred. This reduces waste and improves product quality during startup or upset conditions. Another benefit is that the process will be able to achieve steady state more quickly. The mixed rare earth feedstock has significant value and it is not desirable to waste any by sending elements into the waste streams from the solvent extraction process.

### Variations

It should be understood that numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A solvent extraction (SX) cell comprising:
a. a mixer, comprising one or more sample port across a height of the mixer and a mixer impeller for drawing an organic phase fluid and an aqueous phase fluid into the mixer from a bottom inlet and/or for mixing said fluids in the mixer;
b. at least one sensor adapted to analyze samples from the one or more sample port;
c. a fluid retaining collar, at the inlet around a lower portion of the mixer impeller;
d. a mixer impeller drive;
e. a controller, adapted to adjust a vertical position of the mixer impeller and/or a rotational speed of the mixer impeller responsive to at least analysis of the samples; and
f. a settler, operatively connected with the mixer.

2. The SX cell according to claim 1, wherein the mixer impeller drive comprises:
an upper disk, having a mixer impeller diameter d, comprising at least one recirculation opening;
a plurality of vanes, extending away from the upper disk to a lower opening inlet of the mixer impeller;
a distance between the upper disk and the lower opening defining a mixer impeller height h,
wherein a mixer impeller ratio of h/d is greater than 1.

3. The SX cell according to claim 1 or 2, further comprising an automated interface regulator, the automated interface regulator comprising:
an aqueous take off divider having an open bottom portion and an adjustable interface regulator, the settler comprising the aqueous take off divider;
one or more interface detection sensor adapted to identify at least an interface between an aqueous layer surface and emulsion layer in the settler; and
an automatic interface regulator control, adapted to adjust a height of the adjustable interface regulator responsive at least to the one or more interface detection sensor.

4. The SX cell according to any one of claims 1 to 3, operatively connected to one or more additional SX cells to form a battery of SX cells.

5. The battery of SX cells according to claim 4, further comprising a water seal, the water seal comprising:
a trough, extending around an outer perimeter of an outer wall of the battery, the trough adapted to contain a level of water;
a lid having serrated edge extending around a perimeter of the lid, the edge adapted to sit in the trough,
wherein the water seal is formed between the lid and the outer wall.

6. The battery of SX cells according to claim 4 or 5, further comprising:
at least one shared wall between adjacent SX cells; and
at least one internal flow channel between the operatively connected SX cells.

7. The SX cell according to any one of claims 1 to 4, said SX cell comprising a plurality of flat sheet parts adapted for assembly into the mixer and/or the settler, wherein the parts may be stacked flat for efficient transportation and then assembled at a desired location.

8. A mixer impeller for a mixer of a solvent extraction (SX) cell comprising:
a. an upper disk, having a mixer impeller diameter d, comprising at least one recirculation opening;
b. a plurality of vanes, extending away from the upper disk to a lower opening inlet of the mixer impeller;
c. a distance between the upper disk and the lower opening defining a mixer impeller height h,
wherein a mixer impeller ratio of h/d is greater than 1.

9. An automated interface regulator for a solvent extraction (SX) cell comprising:
a. a settler, comprising an aqueous take off divider having an open bottom portion and an adjustable interface regulator;
b. one or more interface detection sensor adapted to identify at least an interface between an aqueous layer surface and emulsion layer in the settler;
c. an automatic interface regulator control, adapted to adjust a height of the adjustable interface regulator responsive at least to the one or more interface detection sensor; and
d. a mixer, operatively connected with the settler.

10. A water seal for a battery of solvent extraction (SX) cells comprising:
a. a plurality of mixers and settlers operatively connected;
b. a trough, extending around an outer perimeter of an outer wall of the battery, the trough adapted to contain a level of water;
c. a lid having serrated edge extending around a perimeter of the lid, the edge adapted to sit in the trough,
wherein the water seal is formed between the lid and the outer wall.

11. A battery of solvent extraction (SX) cells comprising:
a. a plurality of mixers and a plurality of settlers operatively connected in a modular layout;
b. at least one shared wall between adjacent solvent extraction cells; and
c. at least one internal flow channel between the operatively connected solvent extraction cells.

12. A pack flat solvent extraction (SX) cell comprising a plurality of flat sheet parts, said plurality of flat sheet parts adapted for assembly into a mixer and/or a settler for a solvent extraction cell at a desired location, wherein the parts may be stacked flat for efficient transportation and then assembled at the desired location.
